(19) United States
(12) Patent Application Publication
(10) Pub. No.: US 2017/0349139 A1
(43) Pub. Date: Dec. 7, 2017

(54) ANTI-THEFT SYSTEM FOR DRIVERLESS VEHICLE

(71) Applicant: Baidu Online Network Technology (Beijing) Co., Ltd., Beijing (CN)

(72) Inventor: Yifan ZHANG, Beijing (CN)

(21) Appl. No.: 15/282,673

(22) Filed: Sep. 30, 2016

(30) Foreign Application Priority Data
Jun. 1, 2016 (CN) 201610383309.2

(51) Int. Cl. B60R 25/01; B60R 25/33; B60R 25/30; G05D 1/02; B60R 25/102

(52) U.S. Cl. CPC B60R 25/01; G05D 1/0276; B60R 25/102; B60R 25/305; B60R 25/33

(57) ABSTRACT

Disclosed embodiments include an anti-theft system for a driverless vehicle. In some embodiments, the anti-theft system for a driverless vehicle includes an on-board device installed on the driverless vehicle, a server in communication with the on-board device, and a terminal in communication with the server: the terminal configured to send state information about states of the driverless vehicle to the server; the server configured to receive the state information sent by the terminal and to store the state information; and the on-board device configured to acquire the state information stored in the server, and execute a preset operation when the state of the driverless vehicle is determined to be the abnormal state according to the state information.

### CROSS-REFERENCE TO RELATED APPLICATIONS

This application is related to and claims priority from Chinese Application No. 201610383309.2, filed on Jun. 1, 2016, entitled “ANTI-THEFT SYSTEM FOR DRIVERLESS VEHICLE”, the entire disclosure of which is hereby incorporated by reference.

### TECHNICAL FIELD

The present application relates to the field of vehicle technology, specifically to the field of intelligent vehicle technology, and more specifically to an anti-theft system for a driverless vehicle.

### BACKGROUND

A driverless vehicle is a novel intelligent automobile. The driverless vehicle mainly uses an on-board device (that is, a vehicle-mounted intelligent brain) to perform precise control, computation and analysis for various parts of the vehicle, and finally send instructions to an electronic control unit (ECU) to respectively control different devices in the driverless vehicle. In this way, fully automatic driving of the vehicle is realized, thereby achieving driverless driving of the vehicle.

As the commercialization of driverless vehicles approaches, future driverless vehicles will be driven without a driver. The vehicles will be automatically driven to transport passengers and goods, even public transportation means, express delivery conveyances, or the like. Thus, to ensure the property safety of a driverless vehicle, preventing the vehicle from being stolen or finding a lost vehicle will be an important requirement.

### SUMMARY

An objective of some embodiments of the present application is to provide an improved anti-theft system for a driverless vehicle, in order to solve the technical problem mentioned in the foregoing Background section.

In the first aspect, some embodiments of the present application provide an anti-theft system for a driverless vehicle, comprising an on-board device installed on the driverless vehicle, a server in communication with the on-board device, and a terminal in communication with the server: the terminal configured to send state information about states of the driverless vehicle to the server, the states of the driverless vehicle comprising a normal state and an abnormal state; the server configured to receive the state information sent by the terminal and to store the state information; and the on-board device configured to acquire the state information stored in the server, and execute a preset operation when the state of the driverless vehicle is determined to be the abnormal state according to the state information.

In some embodiments, the abnormal state comprises a lost state, wherein: the on-board device is configured to send position information of the driverless vehicle and/or image information captured by an on-board camera of the driverless vehicle to the server when the acquired state is the lost state; and the server is configured to send the position information of the driverless vehicle and/or the image information captured by the on-board camera of the driverless vehicle to the terminal.

In some embodiments, the server is further configured to: in response to receiving a retrieval instruction sent by the terminal, send information of a destination indicated by the retrieval instruction to the on-board device, so that the on-board device controls the driverless vehicle to start an automatic drive mode and drive to the destination; and in response to receiving an alarm instruction sent by the terminal, send the position information of the driverless vehicle and/or the image information captured by the on-board camera of the driverless vehicle to a third-party alarm platform.

In some embodiments, the abnormal state comprises a stolen state: the on-board device is configured to send position information of the driverless vehicle and/or image information captured by an on-board camera of the driverless vehicle to the server when the acquired state is the stolen state; and the server is configured to send the position information of the driverless vehicle and/or the image information captured by the on-board camera of the driverless vehicle to a third-party alarm platform.

In some embodiments, the server is further configured to: in response to receiving the retrieval instruction sent by the third-party alarm platform, send information of a destination indicated by the retrieval instruction to the on-board device, so that the on-board device controls the driverless vehicle to start an automatic drive mode and drive to the destination, the destination comprising a third-party organization near the driverless vehicle.

In some embodiments, when the driverless vehicle is initially started, the on-board device is further configured to acquire a first license plate number and first vehicle owner information input by a user, and send the first license plate information, the first vehicle owner information together with locally prestored vehicle information to the server, and wherein the first vehicle owner information comprises first vehicle owner identification information and a first vehicle owner contact information, and the vehicle information comprises at least one of a vehicle identifier, vehicle brand, model, and appearance information.

In some embodiments, the terminal is further configured to acquire a second license plate number and second vehicle owner information input by the user, and send the second license plate information and the second vehicle owner information to the server, and the second vehicle owner information comprises second vehicle owner identification and contact information.

In some embodiments, the server is further configured to: acquire the first license plate information, the first vehicle owner information, the second license plate information, and the second vehicle owner information; determine whether the first license plate information is consistent with the second license plate information and whether the first vehicle owner information is consistent with the second vehicle owner information; and if the first license plate information is determined to be consistent with the second license plate information and the first vehicle owner information is determined to be consistent with the second vehicle owner information, send the vehicle information to the terminal.

In some embodiments, the terminal is further configured to log into an account, and the server is further configured to store a corresponding relationship of the account logged in by the terminal and the vehicle information.

In some embodiments, the server is configured to: send first verification information by using the first vehicle owner contact information when the state sent by the terminal is the abnormal state; and store the abnormal state in response to receiving the second verification information sent by the terminal consistent with the first verification information.

The anti-theft system for a driverless vehicle provided in some embodiments of the present application comprises an on-board device installed on the driverless vehicle, a server in communication with the on-board device, and a terminal in communication with the server: the terminal configured to send state information about states of the driverless vehicle to the server; the server configured to receive the state information sent by the terminal and to store the state information; and the on-board device configured to acquire the state information stored in the server, and execute a preset operation when the state of the driverless vehicle is determined to be the abnormal state according to the state information. In this way, the monitoring on the state of the driverless vehicle and the control on the driverless vehicle are achieved through the interactions among the vehicle-mounted device, the server and the terminal, thereby ensuring the security of the driverless vehicle.

### BRIEF DESCRIPTION OF THE DRAWINGS

Other features, objectives and advantages of the present application will become more apparent upon reading the detailed description to non-limiting embodiments with reference to the accompanying drawings, wherein:

FIG. 1 is an architectural diagram of a system in which some embodiments of the present application may be implemented;

FIG. 2 is a flow chart of an anti-theft system for a driverless vehicle according to an embodiment of the present application;

FIG. 3 is a schematic diagram of an application scenario of an anti-theft system for a driverless vehicle according to some embodiments of the present application;

FIG. 4 is a flow chart of an anti-theft system for a driverless vehicle according to another embodiment of the present application;

FIG. 5 is a flow chart of an anti-theft system for a driverless vehicle according to still another embodiment of the present application;

FIG. 6 is a flow chart of a registration method of an anti-theft system for a driverless vehicle according to some embodiments of the present application; and

FIG. 7 is a schematic diagram of a hardware structure adapted to implement an on-board device, a server or a terminal of the embodiments of the present application.

### DETAILED DESCRIPTION

The present application will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

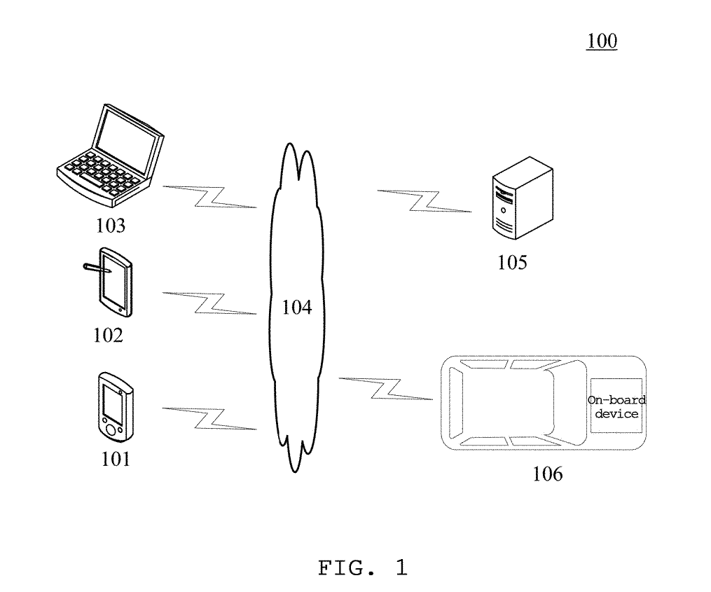

FIG. 1 shows an architecture of a system 100 in an anti-theft system for a driverless vehicle according to an embodiment of the present application may be implemented.

As shown in FIG. 1, the system architecture 100 may include terminal devices 101, 102 and 103, a network 104, a server 105 and a driverless vehicle 106. An on-board device, which may be an electronic control unit (ECU), is installed on the driverless vehicle 106. The network 104 serves as a medium providing a communication link between the terminal devices 101, 102 and 103 and the server 105. The network 104 may include various types of connections, such as wired or wireless transmission links, or optical fibers.

The user may use the terminal devices 101, 102 and 103 to interact with the server 105 through the network 104, in order to transmit or receive messages, etc. Various software, such as management software for a driverless vehicle which may receive state information about states of the driverless vehicle input be a user and send the state information to the server 105, may be installed on the terminal devices 101, 102 and 103. The terminal devices 101, 102 and 103 include but not limited to, smart phones, tablet computers, laptop computers and desktop computers.

The server 105 may be a server providing services for the programs running on the terminal devices 101, 102 or 103. The server 105 receives and stores the state information sent by the user through the terminal devices 101, 102 and 103, and may send the information to the on-board device.

The on-board device may acquire the state information stored in the server 105 and execute a preset operation when the state of the driverless vehicle 106 is determined to be an abnormal state according to the state information.

It should be appreciated that the numbers of the terminal devices, the networks and the servers in FIG. 1 are merely illustrative. Any number of terminal devices, networks and servers may be provided based on the actual requirements.

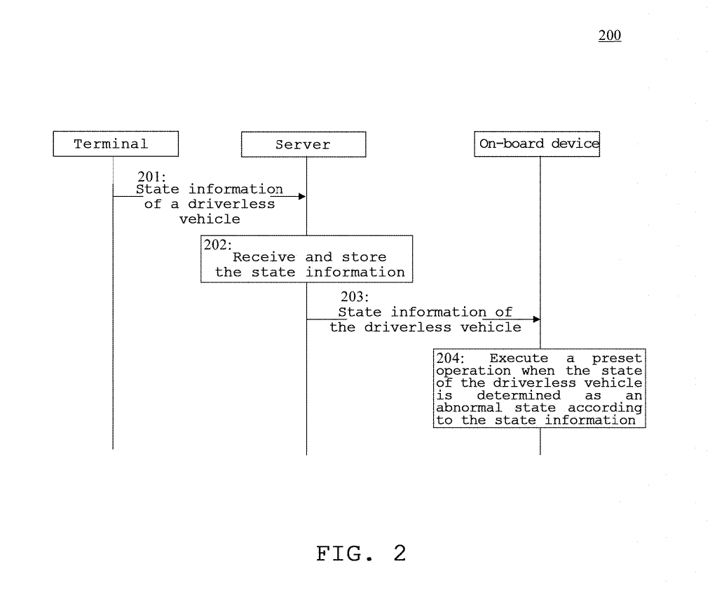

Further referring to FIG. 2, it shows a flow chart of an anti-theft system for a driverless vehicle according to an embodiment of the present application.

The anti-theft system for a driverless vehicle in some embodiments of the present application comprises an on-board device installed on the driverless vehicle, a server in communication with the on-board device, and a terminal in communication with the server. The terminal is configured to send state information about states of the driverless vehicle to the server, and the states of the driverless vehicle comprise a normal state and an abnormal state. The server is configured to receive the state information sent by the terminal and to store the state information. The on-board device is used to acquire the state information stored in the server, and execute a preset operation when the state of the driverless vehicle is determined to be the abnormal state according to the state information.

As shown in FIG. 2, in step 201, the terminal sends the state information of the driverless vehicle to the server.

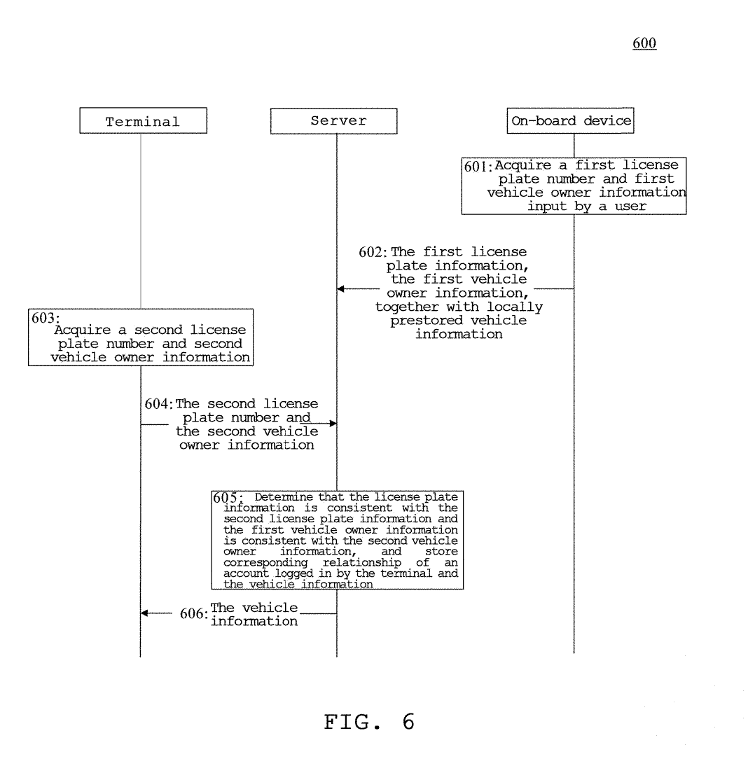

In this embodiment, the server may be considered as a cloud computing platform formed by a plurality of servers, for storing relevant data of the driverless vehicle. An account registered to the cloud computing platform may be logged in on the terminal. Also, the terminal may submit a registration request when sending the state information of the driverless vehicle. The specific registration method may be seen from FIG. 6. The state of the driverless vehicle comprises a normal state and an abnormal state, and different types of states may be specifically set according to requirements. The terminal may send the state information of the driverless vehicle to the server periodically, and also may send changed state information of the driverless vehicle to the server merely when the state input by a user is changed.

In step 202, the server receives and stores the state information sent by the terminal.

In this embodiment, the server may receive and store the state information sent by the terminal. The server may also perform verification by some verification means, for example, short message verification, and store the state information sent by the terminal after the verification is successful.

In step 203, the on-board device acquires the state information of the driverless vehicle stored in the server.

In this embodiment, in order to acquire the state information of the driverless vehicle stored in the server, the on-board device may send a request for acquiring information to the server periodically, or may wait for the server to actively send the abnormal state information to the on-board device in response to receiving the abnormal state information sent by the terminal.

In step 204, the on-board device executes a preset operation when the state of the driverless vehicle is determined to be an abnormal state according to the state information.

In this embodiment, the on-board device executes a preset operation when the state of the driverless vehicle is determined to be an abnormal state according to the state information, and the preset operation varies according to different states.

In some alternative implementations of this embodiment, the abnormal state comprises a lost state. The on-board device is configured to send position information of the driverless vehicle and/or image information captured by an on-board camera of the driverless vehicle to the server when the acquired state is the lost state. The server is configured to send the position information of the driverless vehicle and/or the image information captured by the on-board camera of the driverless vehicle to the terminal.

In some alternative implementations of this embodiment, the server is further configured to: in response to receiving a retrieval instruction sent by the terminal, send information of a destination indicated by the retrieval instruction to the on-board device, so that the on-board device controls the driverless vehicle to start an automatic drive mode and drive to the destination; and in response to receiving an alarm instruction sent by the terminal, send the position information of the driverless vehicle and/or the image information captured by the on-board camera of the driverless vehicle to a third-party alarm platform.

In some alternative implementations of this embodiment, the abnormal state comprises a stolen state. The on-board device is configured to send position information of the driverless vehicle and/or image information captured by an on-board camera of the driverless vehicle to the server when the acquired state is the stolen state. The server is configured to send the position information of the driverless vehicle and/or the image information captured by the on-board camera of the driverless vehicle to a third-party alarm platform.

In some alternative implementations of this embodiment, the server is further configured to: in response to receiving the retrieval instruction sent by the third-party alarm platform, send information of a destination indicated by the retrieval instruction to the on-board device, so that the on-board device controls the driverless vehicle to start an automatic drive mode and drive to the destination. The destination comprises a third-party organization near the driverless vehicle.

In some alternative implementations of this embodiment, when the driverless vehicle is initially started, the on-board device is further configured to acquire a first license plate number and first vehicle owner information input by a user, and to send the first license plate information, the first vehicle owner information together with locally prestored vehicle information to the server. The first vehicle owner information comprises first vehicle owner identification information and first vehicle owner contact information. The vehicle information comprises at least one of a vehicle identifier, vehicle brand, model, and appearance information.

In some alternative implementations of this embodiment, the terminal is further configured to acquire a second license plate number and second vehicle owner information input by the user, and to send the second license plate information and the second vehicle owner information to the server. The second vehicle owner information comprises second vehicle owner identification and contact information.

In some alternative implementations of this embodiment, the server is further configured to: acquire the first license plate information, the first vehicle owner information, the second license plate information, and the second vehicle owner information; determine whether the first license plate information is consistent with the second license plate information and whether the first vehicle owner information is consistent with the second vehicle owner information; and if the first license plate information is determined to be consistent with the second license plate information and the first vehicle owner information is determined to be consistent with the second vehicle owner information, send the vehicle information to the terminal.

In some alternative implementations of this embodiment, the terminal is further configured to log into an account, and the server is further configured to store a corresponding relationship of the account logged in by the terminal and the vehicle information.

In some alternative implementations of this embodiment, the server is configured to: send first verification information by using the first vehicle owner contact information when the state sent by the terminal is the abnormal state; and store the abnormal state in response to receiving the second verification information sent by the terminal consistent with the first verification information.

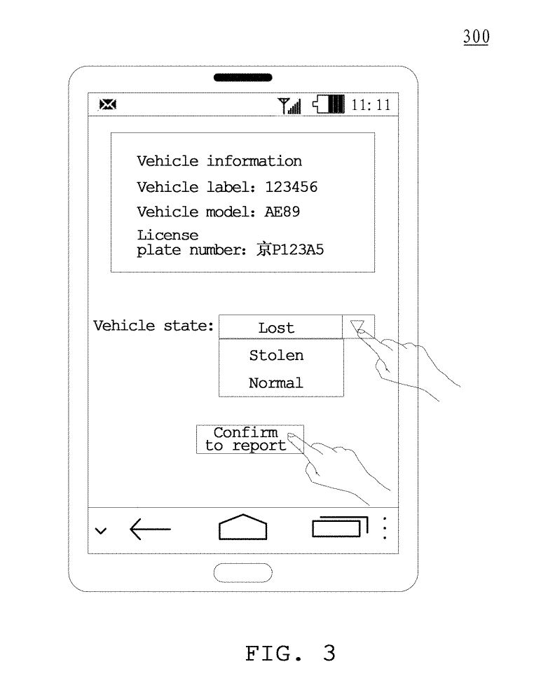

Further referring to FIG. 3, FIG. 3 is a schematic diagram of an application scenario of an anti-theft system for a driverless vehicle according to this embodiment. In the application scenario of FIG. 3, a user reports vehicle state information by using driverless vehicle management software installed in the terminal or by accessing a driverless vehicle management website. In an interface 300, the user may input vehicle information, select a vehicle state, and confirm to report. The vehicle information may also be prestored in the terminal locally.

By means of the anti-theft system for a driverless vehicle provided in this embodiment, the state information of the driverless vehicle is sent to the server by the terminal. The on-board device acquires the state information received and stored by the server, and executes the preset operation when the state of the driverless vehicle is determined to be an abnormal state according to the state information. In this way, the monitoring on the state of the driverless vehicle and the control on the driverless vehicle are achieved, thereby ensuring the security of the driverless vehicle.

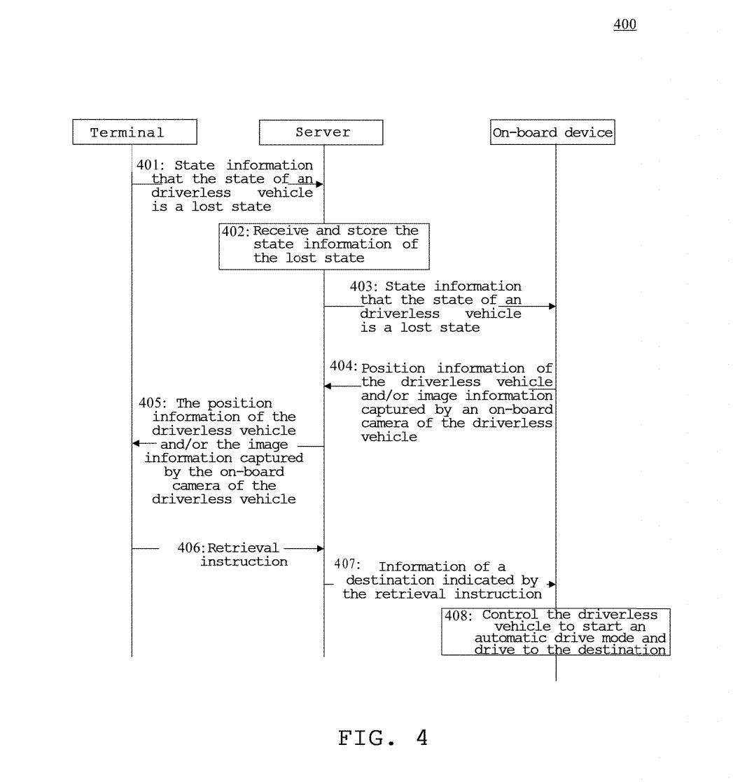

Further referring to FIG. 4, which shows a flow chart of an anti-theft system for a driverless vehicle according to another embodiment of the present application.

In step 401, a terminal sends state information that a state of a driverless vehicle is a lost state to a server.

In this embodiment, the lost state refers to that the user forgets the position where the driverless vehicle drives to. In the management software of the driverless vehicle in a terminal device, an option of lost state and a description on the operation of the driverless vehicle corresponding to the lost state may be provided for the user's reference and selection.

In step 402, the server receives and stores the state information of lost state sent by the terminal.

In step 403, an on-board device acquires the state information that the state of the driverless vehicle is a lost state stored in the server.

In this embodiment, in order to acquire the state information of the driverless vehicle stored in the server, the on-board device may send a request for acquiring information to the server periodically, or may wait for the server to actively send the state information of the lost state to the on-board device in response to receiving the state information of the lost state sent by the terminal.

In step 404, the on-board device sends position information of the driverless vehicle and/or image information captured by an on-board camera of the driverless vehicle to the server.

In this embodiment, the image information captured by the on-board camera may comprise image information around the driverless vehicle, and may also comprise image information inside the driverless vehicle. The image information around the driverless vehicle may assist to determine the position of the driverless vehicle.

In step 405, the server sends the position information of the driverless vehicle and/or the image information captured by the on-board camera of the driverless vehicle to the terminal.

In step 406, the terminal sends a retrieval instruction to the server.

In this embodiment, the retrieval instruction comprises information of a destination set by the user using the terminal.

In step 407, the server sends the information of the destination indicated by the retrieval instruction to the on-board device.

In step 408, the on-board device controls the driverless vehicle to start an automatic drive mode and drive to the destination.

By means of the anti-theft system for a driverless vehicle provided in this embodiment, the terminal sends the state information that the state of the driverless vehicle is the lost state to the server. When the on-board device acquires the state information that the state of the driverless vehicle is the lost state, the on-board device provides the position information of the driverless vehicle and/or the image information captured by the on-board camera of the driverless vehicle. In this way, when the driverless vehicle is lost, the position of the driverless vehicle can be determined and the driverless vehicle can be automatically retrieved.

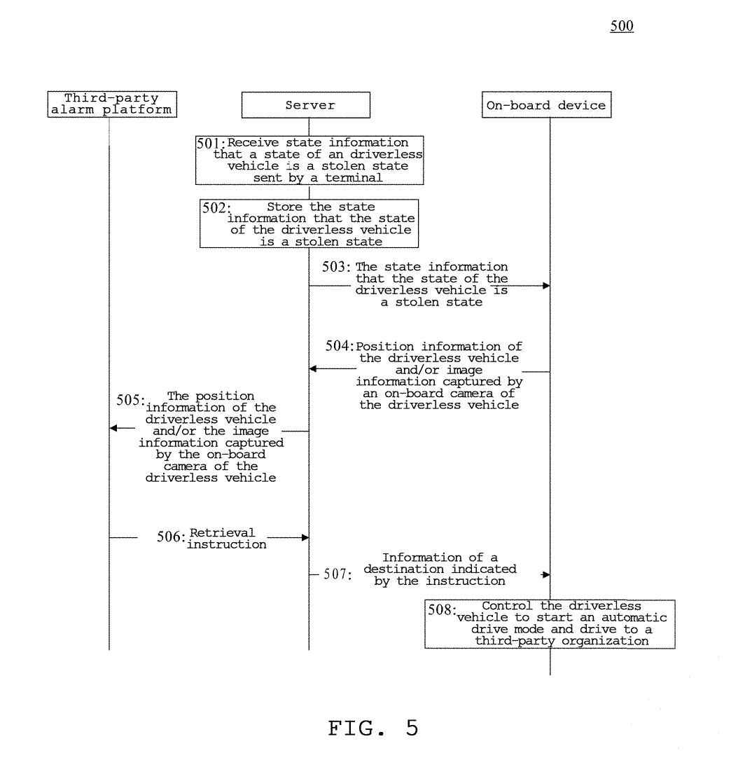

Further referring to FIG. 5, which shows a flow chart of an anti-theft system for a driverless vehicle according to still another embodiment of the present application.

In step 501, a server receives state information that a state of a driverless vehicle is a stolen state sent by a terminal.

In this embodiment, the stolen state refers to that the driverless vehicle should drive to a position, but the driverless vehicle cannot be found in that position. This is generally caused by an act of theft of a lawbreaker.

In step 502, the server stores the state information that the state of the driverless vehicle is the stolen state.

In step 503, the on-board device acquires the state information of the state of the driverless vehicle is the stolen state stored in the server.

In step 504, the on-board device sends position information of the driverless vehicle and/or image information captured by an on-board camera of the driverless vehicle to the server.

In step 505, the server sends the position information of the driverless vehicle and/or the image information captured by the on-board camera of the driverless vehicle to a third-party alarm platform.

In this embodiment, since the state of the driverless vehicle is the stolen state, a suspect may be in the driverless vehicle. Therefore, the third-party alarm platform needs to be involved to capture the suspect, thereby preventing an owner of the driverless vehicle from directly contacting with the suspect to cause unnecessary potential risks. The third-party alarm platform may be a network alarm platform of a public security organization such as a police office, or a security company.

In step 506, the third-party alarm platform sends a retrieval instruction to the server.

In step 507, the server sends information of the destination indicated by the retrieval instruction to the on-board device.

In step 508, the on-board device controls the driverless vehicle to start an automatic drive mode and drive to a third-party organization.

In this embodiment, the third-party organization may be a public security organization such as a police office near the driverless vehicle.

By means of the anti-theft system for a driverless vehicle provided in this embodiment, the terminal sends the state information that the state of the driverless vehicle is the stolen state to the server. When the on-board device acquires the state information that the state of the driverless vehicle is the stolen state, the on-board device provides the position information of the driverless vehicle and/or the image information captured by the on-board camera of the driverless vehicle to the third-party alarm platform. In this way, when the driverless vehicle is stolen, the position of the driverless vehicle can be determined and the driverless vehicle can drive to a safety position. Further referring to FIG. 6, which shows a flow chart of a registration method of an anti-theft system for a driverless vehicle.

In step 601, on-board device acquires a first license plate number and first vehicle owner information input by a user.

In step 602, the on-board device sends the first license plate information and the first vehicle owner information together with prestored locally vehicle information to the server.

In this embodiment, the vehicle information comprises at least one of: a vehicle identifier, vehicle brand, model and appearance information. The vehicle identifier may also be another code that can be used to uniquely determine the driverless vehicle.

In step 603, the terminal acquires a second license plate number and second vehicle owner information input by the user.

In step 604, the terminal sends the second license plate information and the second vehicle owner information to the server.

In step 605, the server stores a corresponding relationship of an account logged in by the terminal and the vehicle information when the first license plate information is determined to be consistent with the second license plate information and the first vehicle owner information is determined to be consistent with the second vehicle owner information.

In step 606, the server sends the vehicle information to the terminal.

By means of the registration method of the anti-theft system for a driverless vehicle shown in FIG. 6, the security of the anti-theft system for a driverless vehicle is improved, thereby avoiding a person who is not the owner of the driverless vehicle from controlling the driverless vehicle remotely.

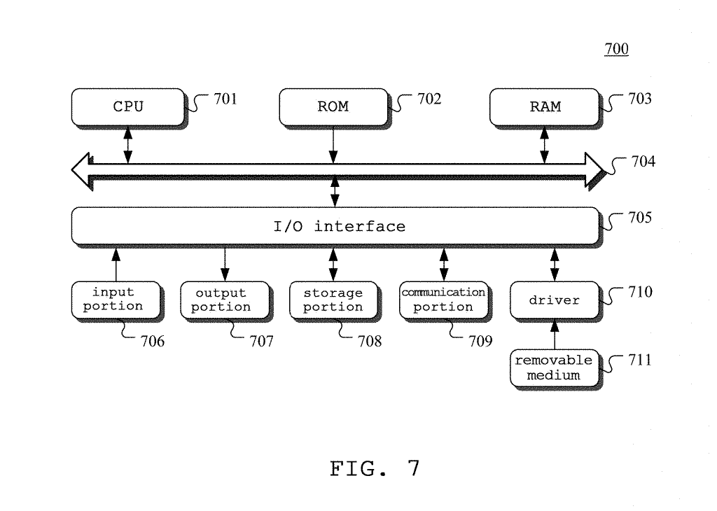

Referring to FIG. 7, a schematic diagram of a hardware structure adapted to implement an on-board device, a server or a terminal of the embodiments of the present application is shown.

As shown in FIG. 7, the vehicle-mounted intelligent device 700 includes a central processing unit (CPU) 701, which may execute various appropriate actions and processes in accordance with a program stored in a read-only memory (ROM) 702 or a program loaded into a random access memory (RAM) 703 from a storage portion 708. The RAM 703 also stores various programs and data required by operations of the system 700. The CPU 701, the ROM 702 and the RAM 703 are connected to each other through a bus 704. An input/output (I/O) interface 705 is also connected to the bus 704.

The following components are connected to the I/O interface 705: an input portion 706 including a keyboard, a mouse etc.; an output portion 707 comprising an ECU etc.; a storage portion 708 including a hard disk and the like; and a communication portion 709 comprising a network interface card, such as a LAN card and a modem. The communication portion 709 performs communication processes via a network, such as the Internet. A driver 710 is also connected to the I/O interface 705 as required. A removable medium 711, such as a magnetic disk, an optical disk, a magneto-optical disk, and a semiconductor memory, may be installed on the driver 710, to facilitate the retrieval of a computer program from the removable medium 711, and the installation thereof on the storage portion 708 as needed.

The foregoing is a description of some embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. An anti-theft system for a driverless vehicle, comprising an on-board device installed on the driverless vehicle, a server in communication with the on-board device, and a terminal in communication with the server:
the terminal configured to send state information about states of the driverless vehicle to the server, the states of the driverless vehicle comprising a normal state and an abnormal state;
the server configured to receive the state information sent by the terminal and to store the state information; and
the on-board device configured to acquire the state information stored in the server, and execute a preset operation when the state of the driverless vehicle is determined to be the abnormal state according to the state information.

2. The system according to claim 1, wherein the abnormal state comprises a lost state, and wherein:
the on-board device is configured to send position information of the driverless vehicle and/or image information captured by an on-board camera of the driverless vehicle to the server when the acquired state is the lost state; and
the server is configured to send the position information of the driverless vehicle and/or the image information captured by the on-board camera of the driverless vehicle to the terminal.

3. The system according to claim 2, wherein the server is further configured to:
in response to receiving a retrieval instruction sent by the terminal, send information of a destination indicated by the retrieval instruction to the on-board device, so that the on-board device controls the driverless vehicle to start an automatic drive mode and drive to the destination; and
in response to receiving an alarm instruction sent by the terminal, send the position information of the driverless vehicle and/or the image information captured by the on-board camera of the driverless vehicle to a third-party alarm platform.

4. The system according to claim 1, wherein the abnormal state comprises a stolen state:
the on-board device is configured to send position information of the driverless vehicle and/or image information captured by an on-board camera of the driverless vehicle to the server when the acquired state is the stolen state; and
the server is configured to send the position information of the driverless vehicle and/or the image information captured by the on-board camera of the driverless vehicle to a third-party alarm platform.

5. The system according to claim 4, wherein the server is further configured to:
in response to receiving the retrieval instruction sent by the third-party alarm platform, send information of a destination indicated by the retrieval instruction to the on-board device, so that the on-board device controls the driverless vehicle to start an automatic drive mode and drive to the destination, the destination comprising a third-party organization near the driverless vehicle.

6. The system according to claim 1, wherein when the driverless vehicle is initially started, the on-board device is further configured to acquire a first license plate number and first vehicle owner information input by a user, and send the first license plate information, the first vehicle owner information together with locally prestored vehicle information to the server, and wherein the first vehicle owner information comprises first vehicle owner identification information and a first vehicle owner contact information, and the vehicle information comprises at least one of a vehicle identifier, vehicle brand, model, and appearance information.

7. The system according to claim 6, wherein the terminal is further configured to acquire a second license plate number and second vehicle owner information input by the user, and send the second license plate information and the second vehicle owner information to the server, and wherein the second vehicle owner information comprises second vehicle owner identification and contact information.

8. The system according to claim 6, wherein the server is further configured to:
acquire the first license plate information, the first vehicle owner information, the second license plate information, and the second vehicle owner information;
determine whether the first license plate information is consistent with the second license plate information and whether the first vehicle owner information is consistent with the second vehicle owner information; and
if the first license plate information is determined to be consistent with the second license plate information and the first vehicle owner information is determined to be consistent with the second vehicle owner information, send the vehicle information to the terminal.

9. The system according to claim 8, wherein the terminal is further configured to log into an account, and the server is further configured to store a corresponding relationship of the account logged in by the terminal and the vehicle information.

10. The system according to claim 6, wherein the server is configured to:
send first verification information by using the first vehicle owner contact information when the state sent by the terminal is the abnormal state; and
store the abnormal state in response to receiving the second verification information sent by the terminal consistent with the first verification information.

11. An anti-theft method, comprising:
sending, by a terminal to a server, state information about states of a driverless vehicle, the states of the driverless vehicle comprising a normal state and an abnormal state;
receiving and storing, by the server, the state information; and
acquiring the state information, and executing a preset operation, by an on-board device installed on the driverless vehicle, when the state of the driverless vehicle is determined to be the abnormal state according to the state information.

12. The method according to claim 11, wherein the abnormal state comprises a lost state, and wherein acquiring the state information stored, and executing a preset operation, by the on-board device, when the state of the driverless vehicle is determined to be the abnormal state according to the state information comprises:
sending, by the on-board device, position information of the driverless vehicle and/or image information captured by an on-board camera of the driverless vehicle when the acquired state is the lost state; and
sending, by the server, the position information of the driverless vehicle and/or the image information captured by the on-board camera of the driverless vehicle to the terminal.

13. The method according to claim 12, further comprising:
in response to receiving a retrieval instruction sent by the terminal, sending information of a destination indicated by the retrieval instruction to control the driverless vehicle to start an automatic drive mode and drive to the destination; and
in response to receiving an alarm instruction sent by the terminal, sending the position information of the driverless vehicle and/or the image information captured by the on-board camera of the driverless vehicle to a third-party alarm platform.

14. The method according to claim 11, wherein the abnormal state comprises a stolen state, and wherein acquiring the state information, and executing a preset operation, by the on-board device, when the state of the driverless vehicle is determined to be the abnormal state according to the state information comprises:
sending position information of the driverless vehicle and/or image information captured by an on-board camera of the driverless vehicle when the acquired state is the stolen state; and
sending the position information of the driverless vehicle and/or the image information captured by the on-board camera of the driverless vehicle to a third-party alarm platform.

15. The method according to claim 14, further comprising:
in response to receiving the retrieval instruction sent by the third-party alarm platform, sending information of a destination indicated by the retrieval instruction to control the driverless vehicle to start an automatic drive mode and drive to the destination, the destination comprising a third-party organization near the driverless vehicle.

16. A non-transitory storage medium storing one or more programs, the one or more programs when executed by an apparatus, causing the apparatus to perform a driverless vehicle control method, comprising:
sending, by a terminal to a server, state information about states of a driverless vehicle, the states of the driverless vehicle comprising a normal state and an abnormal state;
receiving and storing, by the server, the state information; and
acquiring the state information, and executing a preset operation, by an on-board device installed on the driverless vehicle, when the state of the driverless vehicle is determined to be the abnormal state according to the state information.
